(19) United States
(12) Patent Application Publication
(10) Pub. No.: US 2026/0089155 A1
(43) Pub. Date: Mar. 26, 2026

(54) SYSTEMS AND METHODS FOR MULTI-FACTOR AUTHENTICATION

(71) Applicant: Infobip Ltd., London (GB)

(72) Inventor: Kwok Onn LOOI, PUCHONG (MY)

(73) Assignee: Infobip Ltd., London (GB)

(21) Appl. No.: 18/894,320

(22) Filed: Sep. 24, 2024

(51) Int. Cl. H04L 9/40

(52) U.S. Cl. CPC H04L 63/0838; H04L 2463/082

(57) ABSTRACT

Systems and methods are disclosed for authentication. One or more processors may receive a user transaction request. One or more processors may generate an authentication request data object in response to the user transaction request, wherein the authentication request data object comprises an authentication code and a link. One or more processors may deliver the authentication request data object, including the authentication code and the link, to a pre-registered contact identifier associated with a decentralized identity. One or more processors may receive a response data object from the user selecting the link, wherein the response data object is associated with the decentralized identity and the authentication code. One or more processors may validate a user authentication based on the received response data object. One or more processors may authorize a transaction associated with the user transaction request upon successful validation of the user authentication.

### TECHNICAL FIELD

The present disclosure relates generally to the technical field of user authentication. More particularly, the present disclosure relates to systems and methods for enhancing user authentication through the integration of multiple authentication factors.

### BACKGROUND

Traditional methods of user authentication, such as one-time passwords (OTPs) delivered via SMS, have been widely adopted due to their simplicity and ubiquity. However, these methods are increasingly vulnerable to various security threats, including phishing, social engineering, malware, account takeover, and interception. SMS-based OTPs, while easy to implement and accessible across various devices, suffer from inherent security weaknesses that expose users to potential attacks. These vulnerabilities can result in unauthorized access to user accounts, fraudulent transactions, and a compromised user experience.

This disclosure is directed to addressing challenges such as those mentioned above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of data incident response techniques.

In some aspects, the techniques described herein relate to a computer-implemented method for multi-factor authentication, the method including: receiving, by one or more processors, a user transaction request; generating, by the one or more processors, an authentication request data object in response to the user transaction request, wherein the authentication request data object includes an authentication code and a link; delivering, by the one or more processors, the authentication request data object, including the authentication code and the link, to a pre-registered contact identifier associated with a decentralized identity; receiving, by the one or more processors, a response data object from a user selecting the link, wherein the response data object is associated with the decentralized identity and the authentication code; validating, by the one or more processors, a user authentication based on the received response data object; and authorizing, by the one or more processors, a transaction associated with the user transaction request upon successful validation of the user authentication.

In some aspects, the techniques described herein relate to a system including memory and one or more processors communicatively coupled to the memory, the one or more processors configured to: receive a user transaction request; generate an authentication request data object in response to the user transaction request, wherein the authentication request data object includes an authentication code and a link; deliver the authentication request data object, including the authentication code and the link, to a pre-registered contact identifier associated with a decentralized identity; receive a response data object from a user selecting the link, wherein the response data object is associated with the decentralized identity and the authentication code; validate a user authentication based on the received response data object; and authorize a transaction associated with the user transaction request upon successful validation of the user authentication.

In some aspects, the techniques described herein relate to one or more non-transitory computer-readable storage media including instructions that, when executed by one or more processors, cause the one or more processors to: receive a user transaction request; generate an authentication request data object in response to the user transaction request, wherein the authentication request data object includes an authentication code and a link; deliver the authentication request data object, including the authentication code and the link, to a pre-registered contact identifier associated with a decentralized identity; receive a response data object from a user selecting the link, wherein the response data object is associated with the decentralized identity and the authentication code; validate a user authentication based on the received response data object; and authorize a transaction associated with the user transaction request upon successful validation of the user authentication.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system environment, according to some embodiments of the disclosure.

FIG. 2 is a flowchart showing a method for authentication, according to some embodiments of the disclosure.

FIG. 3 is a diagram of one or more steps in a method for authentication, according to some embodiments of the disclosure.

FIG. 4a is a diagram of one or more components in an authentication workflow, according to some embodiments of the disclosure.

FIG. 4b is a diagram of a workflow, according to some embodiments of the disclosure.

FIG. 5 shows an example machine-learning training flow chart, according to some embodiments of the disclosure.

FIG. 6 illustrates an implementation of a computer system that executes techniques presented herein, according to some embodiments of the disclosure.

### DETAILED DESCRIPTION

In some embodiments, the present disclosure pertains to the technical field of user authentication. This disclosure encompasses techniques for authenticating users based on transaction requests. Specifically, it introduces systems and methods configured to combine one-time-passwords (OTPs), mobile transaction authentication numbers (mTANs), one-time tokens, and/or codes (which may be generally referred to here in as one-time-passwords (OTPs) for simplicity) with decentralized identity frameworks, such as Passkeys or Verifiable Credentials, to yield a robust multi-factor authentication mechanism. This mechanism leverages a high level of assurance by incorporating cryptographic credentials and biometric data to validate user identities, ensuring secure authentication for various purposes including customer validation, commercial or financial transactions, or user account management.

Traditional approaches to user authentication for online transactions often rely on static, rule-based systems or simple token-based methods to verify user identities. These methods struggle to securely validate users due to their vulnerability to phishing, social engineering, and other attacks. Consequently, users may experience compromised security, leading to unauthorized access and fraudulent transactions, which undermines user trust and increases the risk of financial losses.

Traditional systems also depend on predefined authentication methods and fixed security protocols. This rigidity hinders their ability to adapt to evolving security threats or incorporate advanced authentication technologies without substantial manual reconfiguration and updates. In the context of rapidly advancing cyber threats and increasing regulatory requirements for data protection, the inability to swiftly implement new security measures or adjust authentication protocols can significantly compromise the robustness of user authentication processes.

Decentralized Identity frameworks, such as Passkeys and Verifiable Credentials, represent an approach to user authentication. These technologies leverage cryptographic methods to ensure the integrity and authenticity of user identities, significantly reducing the risk of common attack vectors. Passkeys, supported by major operating systems and browsers, facilitate passwordless authentication by using biometrics and device possession, thus mitigating the challenges associated with password management and security. Verifiable Credentials (VCs), on the other hand, allow for the issuance and verification of cryptographic credentials by trusted authorities, trusted entities, organizations, and/or enterprises, providing a robust mechanism for identity and qualification verification. For example, a mobile network operator (MNO) may issue their mobile subscribers with a VC to prove valid subscription with their mobile number (MSISDN), providing a robust mechanism for identity and qualification verification.

Despite the security features offered by Decentralized Identity frameworks, their standalone implementation in user authentication processes, particularly for online transactions, presents limitations. These methods do not inherently associate the user with the specific ongoing transaction, a function that OTPs effectively perform by linking the transaction to the user's registered communication identifier, such as one or more of a mobile number (MSISDN), a user account, a user ID, an email address, or the like. Consequently, relying solely on Passkeys or Verifiable Credentials may not provide the necessary transaction-specific assurance required for secure user authentication in online transactions.

To address concerns such as the above, the present disclosure provides systems and methods configured to combine one-time-passwords (OTPs) with decentralized identity frameworks, such as Passkeys or Verifiable Credentials, which may leverage one or more of natural language processing techniques and/or machine learning models to accurately interpret user authentication data. By training on extensive datasets, the system effectively handles the variability and complexity of user behaviors, enabling more precise authentication code generation, cryptographic linking of decentralized identities, and robust validation of user credentials. This enhances the accuracy and security of user authentication, reducing the risk of fraud and unauthorized access.

The proposed system employs a modular and flexible architecture that facilitates integration with existing user registration systems, authentication databases, and transaction processing workflows. By decoupling the authentication interface from the underlying security logic, the system can readily adapt to changes in authentication protocols, regulatory requirements, or threat landscapes without necessitating extensive manual intervention or prolonged system downtime. This adaptability enables businesses to promptly respond to new security challenges, regulatory changes, and operational needs, thereby enhancing the overall security infrastructure.

Additionally, a technical advantage of cryptographically linking two or more authentication methods lies in the enhanced security and integrity of the authentication process. By binding one authentication method, such as a OTP, with another method, such as decentralized identity credentials or biometric data, the system creates a robust multi-factor authentication framework that significantly reduces the potential for compromised, third-party, or fraudulent data to interfere with the process. This cryptographic linkage ensures that the authentication methods are interdependent and must be validated together, effectively minimizing the risk of unauthorized access through single points of failure. The combined verification process demands that an attacker must simultaneously compromise multiple distinct authentication factors, thereby greatly increasing the complexity and effort required for successful exploitation. This multi-layered approach not only enhances the overall security posture but also ensures that user identities are verified with a higher level of assurance, safeguarding sensitive transactions and user accounts from malicious attacks.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

As an illustrative example, consider a practical application wherein a user engages with an online banking platform to perform a financial transaction. This scenario unfolds as follows: the user initiates a transaction request, such as a funds transfer, using the platform. The system, equipped with one or more processors, receives this transaction request and generates an authentication request data object. This data object includes an authentication code (OTP) and a link, which are cryptographically linked to the user's decentralized identity credentials stored in the user's digital wallet.

Following the generation of the authentication request data object, the system delivers the authentication code and the link to the user's pre-registered contact identifier, such as their mobile phone number, Mobile Station International Subscriber Directory Number (MSISDN), email address, and/or the like. The user receives the message and clicks on the link, which directs them to a secure authentication page hosted by the banking platform. On this secure page, the user is prompted to enter the received OTP and perform biometric verification using their registered device.

Upon the user entering the OTP and completing the biometric verification, the system receives a response data object from the user, which includes the OTP and the biometric data. This response data object is cryptographically verified against the previously generated authentication request data object. The system combines the received OTP and biometric data into a single data packet, ensuring that both authentication methods are validated together.

The system then validates the user authentication based on the combined data packet, ensuring that both the OTP and the decentralized identity credentials match the expected values. Upon successful validation, the system authorizes the transaction, allowing the funds transfer to proceed. This process not only secures the transaction but also ensures that the user's identity is verified with a high level of assurance.

This example underscores the robustness of the disclosed system in enhancing security and reducing the risk of fraud. By cryptographically linking multiple authentication methods and validating them together, the system effectively mitigates the potential for unauthorized access and ensures the integrity of the authentication process.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for data extraction.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of user authentication, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on. ” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and/or “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

As used herein, a ‘cryptographic credential’ may refer to a secure digital key or certificate used to verify the identity of a user or entity in a cryptographic system. Cryptographic credentials utilize cryptographic techniques, including public key infrastructure (PKI), to ensure authenticity and integrity. Comprising a public key and a private key pair, the public key may be used to verify digital signatures made by the private key, which remains confidential. Digital certificates issued by trusted Certificate Authorities (CAs) bind these keys to specific identities, adding layers of trust. Passkeys, a form of cryptographic credential based on FIDO2/WebAuthn standards, replace passwords by using public key cryptography, enhancing security against phishing and credential stuffing. Other forms include JSON Web Tokens (JWTs), Verifiable Credentials (VCs), and secure hardware tokens like smart cards. These credentials enable secure authentication, data integrity, and communication across various applications, which may provide enhanced security compared to traditional methods.

As used herein, the term “application provider” may refer to an entity that provides one or more services, applications, or platforms to users. In some embodiments, the application provider may interact directly with users, manage user accounts, initiate authentication processes, or perform other functions related to user engagement and service delivery. The specific role and responsibilities of the application provider may vary depending on the implementation and context of the authentication system.

As used herein, the term “relying party” (RP) may refer to an entity that depends on authentication or identity verification provided by another party to grant access to its services, resources, or protected information. In some embodiments, the relying party may be the same entity as the application provider, while in other embodiments, it may be a separate entity. The relying party may have various responsibilities, including but not limited to, requesting authentication, verifying authentication responses, and making access control decisions based on the authentication results.

As used herein, the term “identity provider” (IdP) may refer to an entity responsible for authenticating users and providing identity information or assertions to other parties. In some embodiments, the identity provider may manage user credentials, implement various authentication methods (such as passwords, biometrics, or multi-factor authentication), issue identity tokens or credentials, and communicate authentication results to Relying Parties. The identity provider may be a standalone service or integrated within another entity such as the application provider.

As used herein, the term “service provider” (SP) may refer to an entity that offers specific services or functionalities within the authentication or identity management ecosystem. In some embodiments, a service provider may facilitate communication between other entities, manage cryptographic operations, deliver authentication messages, or provide specialized security services. The exact role and responsibilities of a service provider may vary based on the specific implementation and requirements of the authentication system.

Training a machine-learning model may include one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning mode, the machine-learning model may be deployed in a computer application for use on new input data that it has not been trained on previously.

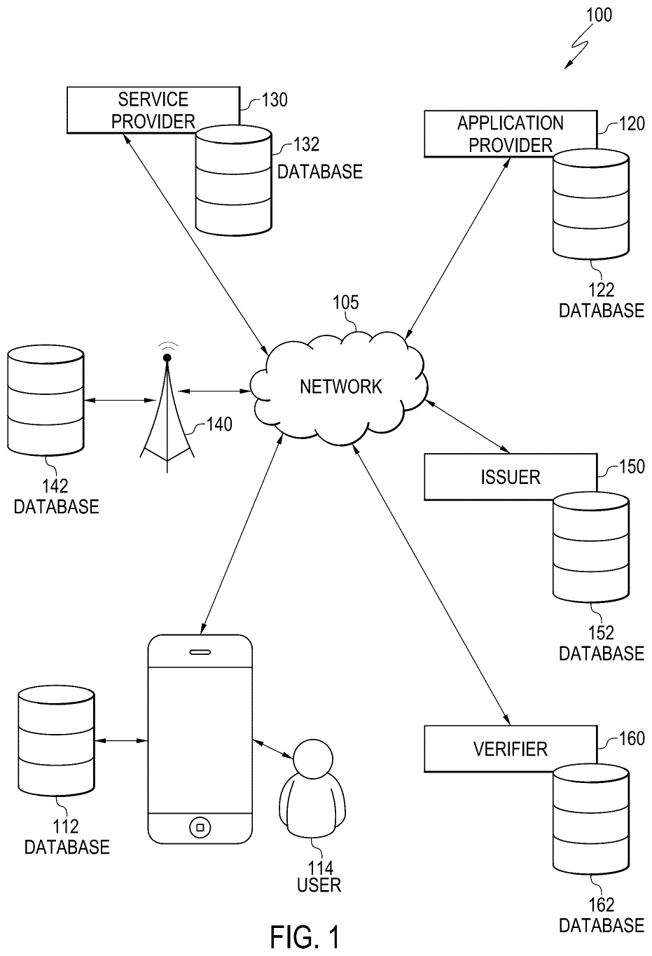

In some embodiments, FIG. 1 illustrates a diagram of a system configured for secure user authentication during online transactions, in accordance with certain embodiments of the present disclosure. The depicted environment, labeled as environment 100, encompasses a communication infrastructure termed network 105, which facilitates connectivity among various components. These components include user devices 110, which are utilized by users to initiate transaction requests and receive authentication data; a database 112 that stores user-specific information such as decentralized identity credentials and biometric data; an application provider 120, responsible for managing user interactions and processing transaction requests; a service provider 130, which offers the platform and infrastructure for conducting transactions; a communications service provider 140, facilitating the delivery of authentication codes and related data to user devices; an issuer 150, which generates and manages the cryptographic credentials required for authentication; and a verifier 160, responsible for validating the authentication data and approving transactions. The system incorporates multiple databases, including database 112, database 122, database 132, database 142, database 152, and database 162, each configured to store and manage distinct sets of data pertinent to user authentication, transaction processing, credential issuance, and verification processes.

In some embodiments, various components within environment 100 interact via network 105. Network 105 facilitates communication among multiple entities, including user device 110, which the user 114 utilizes to initiate transaction requests and receive authentication data. The user device 110 is connected to database 112, which stores user-specific information such as decentralized identity credentials and biometric data. The application provider 120 manages user interactions and processes transaction requests, utilizing database 122 to store application-related data. The service provider 130 offers the platform and infrastructure for conducting transactions, accessing database 132 to store transaction-related information. The communications service provider 140 facilitates the delivery of authentication codes and related data to user devices, maintaining database 142 for storing communication records and related data. The issuer 150 generates and manages cryptographic credentials required for authentication, with database 152 storing credential issuance data. The verifier 160 is responsible for validating the authentication data and approving transactions, relying on database 162 to store verification records and related authentication data. Network 105 may encompass various types of networks, including, but not limited to, data networks, wireless networks, telephony networks, or any combination thereof, to support robust and secure data exchange across environment 100. Within environment 100, any of these components may communicate with one another based on established access permissions, ensuring seamless and secure interaction throughout the authentication process.

In some embodiments, any of the user devices 110, the database 112, and/or one or more other systems and/or databases associated with the authentication provider 120 may contain a diverse collection of structured and/or unstructured data pertinent to user authentication, identities, biometric data, and cryptographic credentials. This data, organized into one or more data objects, spans a variety of dimensions including transaction requests, authentication codes, biometric data, cryptographic credential data, API request and response data related to authentication data exchanges, security and compliance documentation, along with insights from authentication data analytics. This extensive repository, which includes authentication records, identity and biometric data, cryptographic credential data, and the like, may be stored in storage solutions that range from local to cloud-based data storage systems, ensuring secure storage and accessibility for ongoing processing and analytical evaluation of authentication data.

One or more database (112, 122, 132, 142, 152, 162) may support the storage and retrieval of data related to one or more datasets and/or data objects, such as transaction requests, authentication codes, biometric data, cryptographic credential data, and API request and response data related to authentication data exchanges. It stores metadata and operational data about entities represented in these datasets, as well as information received from the authentication pr 120. Database (112, 122, 132, 142, 152, 162) may comprise systems like a relational database management system (RDBMS), NoSQL database, or graph database, tailored to the specific needs and use cases within environment 100, particularly for managing the complex, interconnected data required for secure user authentication.

In some embodiments, database (112, 122, 132, 142, 152, 162) may embody any type of database system where data is systematically arranged in structures such as tables, graphs, or other suitable formats. It is configured to store and facilitate retrieval of data utilized by one or more components of the environment 100, encompassing transaction requests, user identity information, biometric data, cryptographic credentials, data relationships, and platform-generated outcomes. Furthermore, database (112, 122, 132, 142, 152, 162) maintains a vast array of information to aid in the analysis, prediction, and management of authentication-related outcomes based on insights derived from user interactions within environment 100.

In some embodiments, one or more database (112, 122, 132, 142, 152, 162) comprises a machine learning-based analytics database outlining relationships, associations, and connections between input parameters from interaction data and product catalogs, and output parameters representing interaction-related metrics for intent classification, item classification, action performance, and order outcome prediction. This leverages machine learning algorithms to learn mappings between data inputs (e.g., interaction text, user attributes, order history) and outputs such as intent prediction accuracy, item classification effectiveness, action performance precision, and correlations between interaction signals and order outcomes. This analytics database is periodically updated to incorporate additional insights from ongoing machine learning processes.

One or more components within environment 100 interacts with other components within network 105 using established or evolving communication protocols. These protocols ensure efficient interactions between nodes and dictate conventions for creating, sending, and interpreting data exchanges across communication links. They operate across different layers, from generating physical signals to facilitating specific software applications engaged in transmitting or receiving data, enabling robust and secure data flow within environment 100 for comprehensive analysis at the intersection of user interactions and order management outcomes.

Communications between the various components of the networks are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In operation, environment 100 serves as a platform for processing and analyzing interaction data, utilizing techniques such as data analytics, artificial intelligence, and database management. For instance, in an embodiment, environment 100 facilitates the generation of insights, metrics, and data objects from various datasets, including user interaction data and catalogue records, according to predefined criteria or multiple parameters.

In some embodiments, user device 110 is a computing device utilized by user 114 to initiate transaction requests and receive authentication data. User 114 interacts with the authentication platform through user device 110, which may include smartphones, tablets, personal computers, or other network-enabled devices. The user device 110 processes various data objects, such as transaction requests, authentication codes, biometric data, and cryptographic credentials. These data objects are critical for authenticating the user's identity and authorizing transactions. The user device 110 interfaces with the network 105 to communicate with other components in environment 100, ensuring the secure transmission and reception of authentication data.

In some embodiments, application provider 120 is an entity responsible for managing user interactions and processing transaction requests. Application provider 120 may be configured as an intermediary between user devices 110 and the authentication platform, facilitating the initiation and management of authentication processes. The application provider 120 is configured to various data objects, including user transaction requests, authentication request data objects, and user interaction data. These data objects are stored and managed within database 122, which may contain information pertinent to user accounts, transaction histories, and authentication events. The application provider 120 ensures that user transaction requests are securely transmitted to the authentication platform and that authentication responses are appropriately handled, thereby maintaining the security and efficiency of the user authentication process. Additionally, the application provider 120 may generate and manage session tokens, handle user session states, and implement security protocols to protect user data and prevent unauthorized access.

In some embodiments, service provider 130 is configured to offer the platform and infrastructure necessary for conducting transactions within the authentication system. Service provider 130 interacts with various components of environment 100 via network 105 to facilitate the execution and management of transaction requests initiated by user 114 through user device 110. The service provider 130 processes data objects that include transaction details, authentication codes, cryptographic credentials, and interaction logs. These data objects are stored within database 132, which is structured to manage transaction-related information such as transaction histories, authentication outcomes, and related metadata. Service provider 130 is further configured to interface with application provider 120, communications service provider 140, issuer 150, and verifier 160 to ensure integration and secure processing of transaction requests.

In some embodiments, communications service provider 140 is configured to facilitate the delivery of authentication codes and related data to user devices 110. Communications service provider 140 interacts with other components within environment 100 via network 105 to ensure secure and timely transmission of data objects. These data objects include authentication request data objects, one-time passwords (OTPs), and communication logs. The communications service provider 140 manages and stores this information within database 142, which is structured to record communication activities, delivery statuses, and associated metadata. By utilizing various communication channels, such as SMS, email, or push notifications, communications service provider 140 ensures that users receive the necessary authentication codes and links required to complete the authentication process. Additionally, communications service provider 140 is configured to implement security measures to protect data integrity and prevent unauthorized access during data transmission, thereby maintaining the security and reliability of the authentication system.

In some embodiments, issuer 150 is configured to generate and manage cryptographic credentials required for secure user authentication. These credentials include, but are not limited to, Passkeys based on the FIDO2/WebAuthn standards and Verifiable Credentials (VCs). Passkeys are cryptographic keys that replace traditional passwords with a combination of biometry (something the user is) and device possession (something the user has), enhancing security and user convenience. Verifiable Credentials are cryptographic credentials issued by authorized entities to certify an individual's identity, status, or qualifications, such as a national identity, driver's license, or university diploma. Issuer 150 interacts with other components within environment 100 via network 105 to issue and distribute these credentials to user devices 110. The data objects processed by issuer 150 include cryptographic keys, certificates, and issuance logs. Issuer 150 may be configured to manage and store at least a portion of this information within database 152, which is structured to securely hold one or more of credential issuance records, cryptographic key pairs, and associated metadata. The issuer 150 is configured to ensure that cryptographic credentials are generated in accordance with established security protocols and standards, providing a robust foundation for authenticating user identities. The system is configured to implement multi-factor authentication (MFA) using these decentralized identity credentials, which is designed to enhance resistance against fraud. This MFA process is further configured to associate a user with the specific ongoing transaction to be authenticated, thereby increasing the security and reliability of the authentication process.

In some embodiments, verifier 160 is configured to validate authentication data and approve transactions within the secure user authentication system. Verifier 160 interacts with other components within environment 100 via network 105 to receive and process data objects related to user authentication. These data objects include authentication request data objects, response data objects containing one-time passwords (OTPs) and biometric data, and cryptographic credentials such as Passkeys and Verifiable Credentials. Verifier 160 manages and stores this information within database 162, which is structured to securely hold verification records, validation logs, and associated metadata. The verifier 160 is configured to apply cryptographic techniques and validation protocols to ensure the authenticity and integrity of the received data. This includes verifying the cryptographic credentials issued by issuer 150, validating the biometric data and OTPs received from user devices 110, and ensuring that the transaction requests match the authenticated user's identity.

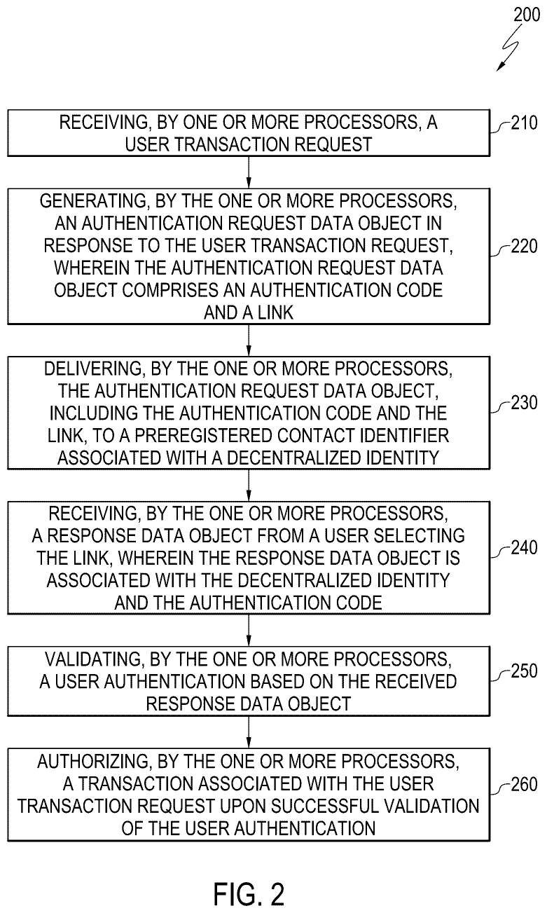

FIG. 2 is a flowchart showing a computer-implemented method 200 for authentication, according to some embodiments of the present invention. In some embodiments, method 200 includes step 210, receiving, by one or more processors, a user transaction request. In some embodiments, the user transaction request is initiated by user 114 through user device 110. The request is transmitted over network 105 to the application provider 120, which processes the request using its platform infrastructure. The user transaction request may pertain to various types of transactions, such as financial transfers, online purchases, and/or access to secure digital services, accounts, and/or databases. The request data object generated by user device 110 includes essential transaction details such as the transaction amount, recipient information, and contextual metadata related to the transaction. This data object is securely transmitted to the application provider 120, where it is temporarily stored in database 122 for further processing. In some embodiments, the user transaction request is generated in response to a first authentication method. This initial authentication may involve the user providing a log-in (username/password) or an account code. The first authentication method ensures that the request originates from an authenticated user before proceeding with further multi-factor authentication steps.

In some embodiments, upon receiving the transaction request, the one or more processors at the application provider 120 parse the request to extract relevant details required for initiating the authentication process. This includes verifying the user identity associated with the request, checking for any pre-existing transaction rules or fraud indicators, and preparing the data for the next authentication steps. The extracted data is then used to generate an initial transaction record, which forms the basis for the subsequent generation of the authentication request data object. This process ensures that all necessary information is captured and validated before proceeding to the authentication steps, thereby enhancing the security and integrity of the transaction.

In some embodiments, method 200 may include step 220, generating, by the one or more processors, an authentication request data object in response to the user transaction request, wherein the authentication request data object comprises an authentication code and a link. The authentication code, such as a one-time password (OTP), is a unique code generated for the specific transaction, and the link directs the user to a secure authentication page, application, or platform. This combination may be configured such that the user receives the necessary credentials to authenticate the transaction securely.

In some embodiments, the authentication code is generated based on details associated with the biometric aspects of the user, details of the transaction, or one or more user-specific details. The one or more processors are configured the transaction request data to determine the appropriate biometric data, such as fingerprints or facial recognition, and other user-specific details, such as device information or transaction history, and base at least a portion of the generation on one or more of these data. This results in the authentication code being uniquely tied to the specific user and transaction, thereby enhancing the security and personalization of the authentication process.

In some embodiments, the generating of the authentication request data object further comprises cryptographically linking the decentralized identity and the authentication code. This cryptographic linking is configured such that the authentication code is securely bound to the user's decentralized identity, preventing unauthorized use or tampering. The one or more processors apply advanced cryptographic techniques, such as public-key cryptography, to establish this secure link, thereby enhancing the integrity and security of the authentication request data object.

In some embodiments, the system applies an machine-learning model to analyze user behavior patterns and actions associated with the user to identify potential fraud before generating the authentication request data object. This analysis is configured to assessing historical transaction data, user behavior patterns, and other contextual information to detect anomalies or suspicious activities. By incorporating machine learning algorithms, the system can dynamically adapt to evolving fraud patterns and enhance the security measures of the authentication process, ensuring that only legitimate transactions are processed.

In some embodiments, the machine-learning model is trained, modified, and configured to find associations between various patterns of historical user data through supervised and unsupervised learning techniques. The training process involves feeding the model large datasets containing historical transaction records, user behavior logs, and known instances of fraudulent activities. The model is configured to identify patterns and correlations within this data, allowing it to recognize typical user behavior and distinguish it from potentially fraudulent activities. The model is continuously updated and refined using new data, ensuring that it remains effective against emerging fraud tactics. Feature engineering techniques are employed to extract relevant features from raw data, such as transaction amounts, time of transactions, device locations, and user response times. These features are used to improve the model's accuracy and predictive capabilities. Additionally, the model may utilize techniques like anomaly detection and clustering to further enhance its ability to identify suspicious activities and reduce false positives, thereby optimizing the overall security and efficiency of the authentication process.

In some embodiments, the machine-learning model is further configured to determine one or more additional authentication technique to use in addition to the one-time password, which may be based on user behavior and potential fraud risks. The model may be trained to modify one or more of weights, layers, synapsis, biases nodes, and/or the like based on training data. By analyzing historical user data and current transaction patterns (training data), the model is configured to dynamically select a suitable third authentication method, such as a passkey, biometric verification, or a cryptographic credential, or the like. This selection process may include evaluating the likelihood of fraud and the user's typical interaction patterns to enhance security. The authentication request data object is then generated to include the machine-learning model's recommended one or more additional authentication type, which may be configured to provide a balance between security and user convenience. This adaptive approach enables the authentication system to respond effectively to varying levels of risk and user behavior.

In some embodiments, the system utilizes a Level of Assurance (LoA) framework to determine suitable authentication methods. The LoA is a measure of the strength and reliability of the authentication process, typically ranging from low to high levels. The system is configured to dynamically assess the required LoA for each transaction based on one or more factors such as transaction value, user behavior patterns, potential fraud risks, regulatory requirements, and the like. For instance, a low-risk transaction might prompt a lower LoA, while a high-risk or sensitive transaction would prompt a higher LoA. In some embodiments, the system may employ a machine-learning model trained on historical transaction data, fraud patterns, and/or user behavior to accurately determine the appropriate LoA for each transaction.

Once the required LoA is determined, the system selects a combination of authentication methods that satisfies the LoA requirements. By way of example, for a low LoA, a single factor such as a one-time password (OTP) might suffice. For medium LoA, the system might require two-factor authentication, combining the OTP with a second method like a security question or a device fingerprint. High LoA transactions might necessitate multi-factor authentication, incorporating biometric verification (e.g., fingerprint or facial recognition) or cryptographic credentials (e.g., passkeys or verifiable credentials) in addition to other methods. It will be appreciated that the foregoing examples are not intended to be limiting, and are provided to aide in understanding of the association between LoA and selection of authentication methods, according to some embodiments.

In some embodiments, the system is further configured to dynamically assess the required LoA for each transaction based on factors related to one or more consumed service, such as transaction type, security requirements, sensitivity of the operation, assessed fraud risk, and specific cryptographic or biometric requirements. In some embodiments, the system is configured to map different LoA levels to specific combinations of authentication factors. For a low LoA, the system may be configured to require a single factor, such as a knowledge factor (e.g., password). For a medium LoA, the system may be configured to require two factors, such as a combination of possession (e.g., device ownership verified through a decentralized identity credential) and knowledge. For a high LoA, the system may be configured to require three factors, including possession, knowledge, and inherence (e.g., biometric verification). The RP service is configured to specify the required LoA for user authentication, which in turn determines the specific authentication methods employed to match the LoA factors.

In some embodiments, method 200 includes step 230, delivering, by the one or more processors, the authentication request data object, including the authentication code and the link, to a pre-registered contact identifier associated with a decentralized identity. In some embodiments, the pre-registered contact identifier may include, but is not limited to, a mobile phone number, MSISDN, email address, or another messaging account associated with the user's decentralized identity. The one or more processors select the appropriate contact identifier from database 112, which contains user-specific contact information. By utilizing pre-registered contact identifiers, the system is configured to deliver the authentication request data object to a verified and trusted recipient, thereby reducing the risk of interception or unauthorized access. In some embodiments, the one or more processors employ secure communication protocols to transmit the authentication request data object. These protocols may include encryption techniques such as TLS (Transport Layer Security) or end-to-end encryption to protect the data during transmission. In some embodiments, the link included in the authentication request data object directs the user to a secure authentication page. This page is configured and/or formatted to present one or more additional challenges based on the required and/or determined level of assurance, to enhance security. These challenges may include, but are not limited to, entering a secondary code sent via a different channel, such as email or SMS; performing a biometric verification, such as fingerprint or facial recognition; answering security questions previously set up by the user; completing a CAPTCHA to ensure human interaction; a passkey, using a time-based one-time password (TOTP) generated by an authentication app, or the like.

In some embodiments, method 200 includes step 240, receiving, by the one or more processors, a response data object from the user selecting the link, wherein the response data object is associated with the decentralized identity and the authentication code. This step ensures that the user has interacted with the secure authentication page and is attempting to authenticate the transaction. In some embodiments, the response data object received from the user further includes biometric data. The one or more processors are configured to capture and incorporate biometric data, such as fingerprints or facial recognition, from the user's device during the authentication process. This biometric data, combined with the authentication code, is configured to enable a multi-factor authentication mechanism that enhances the security of the transaction. The system securely captures this data and associates the data with the user's decentralized identity.

In some embodiments, the method further comprises combining the received authentication code and the biometric data into a single data packet. This combined data packet integrates the two elements required for authentication, ensuring that both factors are validated together. The one or more processors use secure cryptographic techniques to merge the authentication code and biometric data into the data packet, preserving the integrity and confidentiality of the authentication information. In some embodiments, the data packet is used to cryptographically unlock or approve the transaction, wherein the data packet is required to contain data from both the generated authentication code and the biometric data.

In some embodiments, the authentication code (e.g., OTP) is received in a first format, while the biometric data is received in a second format. The one or more processors then combine these two formats into a single data packet in a third format that includes the combined authentication elements. This combined format provides a significant security benefit, as it ensures that even if a fraudulent party intercepts or deciphers either the OTP or the biometric data separately, they would not be able to decipher or utilize the combined authentication in the third format. In some embodiments, there could be three or more authentication codes or methods, each utilizing different formats, such as device-based tokens, knowledge-based answers, or additional biometric data, or the like. The system is configured to reconcile all these different formats into a single, unified data packet, further enhancing the security and robustness of the authentication process.

In some embodiments, method 200 includes step 250, validating, by the one or more processors, a user authentication based on the received response data object. This step is configured to verify that the authentication information provided by the user is legitimate and corresponds to the correct identity. The one or more processors are configured to cross-check the authentication code with the decentralized identity stored in the system to confirm that they match.

In some embodiments, the validation process includes verifying the authenticity of the decentralized identity using a cryptographic credential issued by an authorized entity. The one or more processors are configured to retrieve the cryptographic credential from database 152, ensuring that it is valid and has been issued by a trusted authority. This cryptographic verification involves checking digital signatures and other cryptographic parameters to confirm the credential's integrity and authenticity. By validating both the authentication code and the decentralized identity, the system is configured to validate that the user's identity is accurately confirmed before proceeding with the transaction. In some embodiments, the validation process may include checking the combined data packet for integrated and/or combined approval. This combined approval ensures that all authentication factors are securely validated in a unified manner.

In some embodiments, method 200 includes step 260, authorizing, by the one or more processors, a transaction associated with the user transaction request upon successful validation of the user authentication. Once the user authentication has been validated, the one or more processors proceed to authorize the transaction. This involves updating transaction records in database 132 and notifying relevant parties that the transaction has been approved. The authorization step is configured to verify that the transaction is securely processed and that all authentication requirements have been met.

In some embodiments, method 200, prior to receiving the user transaction request, may include registering, by the one or more processors, the decentralized identity and the contact identifier during a user onboarding process with an application provider. This onboarding process involves collecting user information, such as personal details, biometric data, and contact identifiers like mobile phone numbers or email addresses. The one or more processors create a decentralized identity for the user, store it in database 112, and issue cryptographic credentials through an authorized entity. In this configuration, one or more data object and/or communication, including the delivery of authentication request data objects, is directed to a verified contact point, establishing a secure and reliable foundation for subsequent authentication processes.

In some embodiments, the system is configured to implement a verification process for these decentralized identity credentials during onboarding. This process is configured to request the user to present their credentials, validate the cryptographic integrity of the presented credentials, verify the issuer against a list of trusted issuers, check the current status of the credentials, and assess the level of assurance provided by the credentials.

In some embodiments, the verification process is configured to determine if the required LoA for user authentication using decentralized identity verification can be achieved. The system is configured to associate a higher LoA with the user account if the credentials are determined to be valid and meet the required security standards.

This higher LoA is configured to enable access to services or transactions that require stronger authentication. Conversely, if the credentials fail verification or provide insufficient assurance, the system is configured to support only a lower LoA, potentially limiting the user's access to certain high-security features or transactions. This process is further configured to help determine if the service authentication requirements can be met based on the achievable LoA. The system may be configured to prompt for additional authentication factors or alternative credentials if the initially presented decentralized identity credentials do not meet the required LoA for one or more specific services.

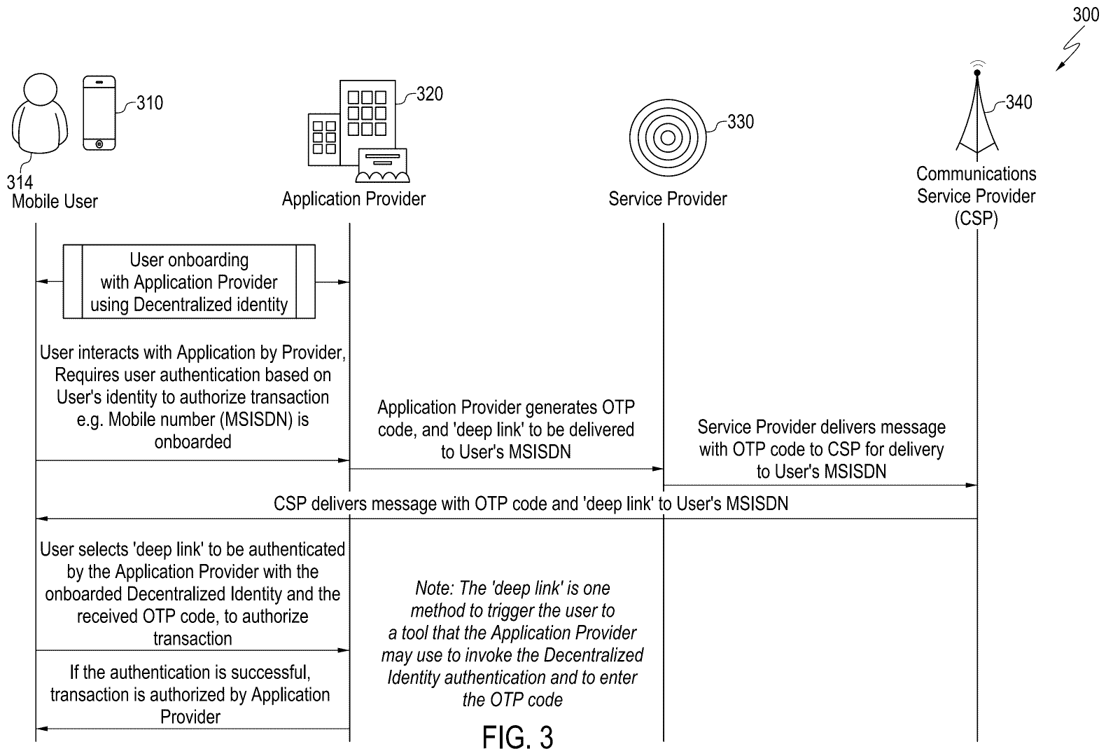

Referring to FIG. 3, a diagram 300 showing a method of authentication utilizing a decentralized identity, such as a passkey, is provided. In some embodiments, the method involves multiple entities and steps to securely authenticate a user 314 using a decentralized identity framework.

In some embodiments, the mobile user 314 receives and/or interacts with one or more service offered by the application provider 320, which may also act as the relying party (RP). In some embodiments, the RP may be a separate entity from the application provider 320, yet still perform the one or more functions described herein. In some embodiments, the application provider 320, acting as the RP is, in some embodiments, configured for delivering the service and may also be configured to handle initial user interactions and transaction requests. Authentication of the users is, in some embodiments, handed by an identity provider (IdP). The application provider 320 may additionally be configured as the IdP by hosting its own authentication service, or it may be configured to engage an external partner to fulfill the IdP role, depending on deployment preferences and commercial considerations. In some embodiments, the relying party, either as a standalone or as part of the application provider 320, may be configured to host their own IdP functions or to engage with one or more external IdP. The IdP, either as part of application provider 320, relying party, or an external partner, is configured for supporting the multi-factor authentication (MFA) requirements and managing the corresponding authentication processes to ensure secure access and transactions for the users.

In some embodiments, the mobile user 314 onboards and registers with the application provider 320, which may be configured to act as the RP and/or the IdP. The onboarding process involves the user providing personal identity information (PII) such as MSISDN, email, and contact details, which may denote a possession factor (something you-have) when one or both of the RP and/or IdP (which may be a part of application provider 320) communicates with the user 314. During this process, the RP and/or IdP may conduct profiling checks on the user-provided identity to detect fraud or malicious intent, potentially employing one or more signal check and/or additional checks to identify fraud or malicious intent. The system is configured to employ one or more signal checks and additional checks to identify fraud or malicious intent. The profiling process is configured to collect user identity information during registration, including name, address, phone number, email, and other relevant data. The system is further configured to analyze the provided information using one or more signals, data entries, and/or machine learning algorithms to detect patterns or anomalies, cross-reference the information with known fraud databases, assess the user's digital footprint, and generate a risk score. Based on this risk score, the system is configured to approve, request additional verification, or reject the account creation attempt. The RP and/or IdP may offer the user 314 the option to create a Passkey in association with the RP and/or IdP service for secured multi-factor authentication. If the user 314 declines, the RP and/or IdP may not offer secured MFA. In cases involving verifiable credentials (VC), the user 314 may be issued one or more VC by an authorized Issuing Party and be asked to present the one or more VC during onboarding for registration. The RP and/or IdP may then associate the user 314 with the VC as their decentralized identity, which may denote a inherence factor (something you-are) when the RP and/or IdP communicates with the user 314. In some embodiments, the user 314 stores their Passkey on their device or their VC in a digital wallet, secured with a device or biometric lock. Additionally, the RP and/or IdP may prompt the user 314 to choose and enter security questions and answers or create a personal identification number (PIN). These responses may denote a knowledge factor (something you-know), further enhancing the security of the onboarding process.

In some embodiments, as the user 314 consumes the service provided by the application provider 320 (where acting as the RP, the IdP, or both), the user 314 may be triggered to authenticate with the IdP in order to complete a pending transaction or verify their identity. The IdP may be configured to performing these authentication functions. The RP and/or IdP is configured to determine one or more multi-factor authentication methods based on a level of assurance (LoA) desired for the service being consumed by the user 314. The LoA desired and/or required may be based on one or more factors, such as the type of transaction, required security, transaction sensitivity, fraud risk, and cryptographic or biometric requirements, and the like.

In some embodiments, different LoA levels dictate various MFA methods. For example, a “normal” LoA may require proof of possession, such as the registered MSISDN or device, using a one-time password (OTP) for authentication. For a “higher” LoA, the user may need to provide both proof of possession and knowledge, requiring an OTP and a PIN or security questions. For an relatively even “higher” LoA, the user may need to demonstrate proof of possession, knowledge, and inherence, necessitating the use of an OTP, PIN, and biometric data for authentication. The RP and/or IdP is configured to prepare the appropriate MFA method based on the determined LoA, in some embodiments using one or more algorithms like time-based one-time-password (TOTP) for OTP generation, where the user's information is associated with a timestamp to generate the code. The length and complexity of the code may vary depending on the LoA/MFA requirements.

In some embodiments, the RP and/or IdP verifies if the user's decentralized identity is registered and corresponds to one or more required LoA and/or MFA requirements. If registered, the RP and/or IdP checks the validity of the user's cryptographic credentials or public keys before proceeding with the MFA. If the credentials are not registered, or are invalid, expired, or revoked, the RP and/or IdP may opt not to proceed with the MFA if the minimum required LoA is not met. Additionally, the RP and/or IdP is configured to consider the channel through which the user is consuming the service. For example, if the user is on a PC browser, the RP and/or IdP may proceed with the MFA on the PC browser and prompt the user to enter the required details, such as the generated code/token, PIN/security questions, and the registered passkey. Alternatively, the RP and/or IdP may switch the user to their device by presenting a QR code with an embedded deep link on the PC browser. Upon scanning the QR code with their device, the user is directed to the associated application, such as a mobile browser, to complete the interaction.

In some embodiments, the system is configured to generate deep links based on one or more criteria to facilitate MFA. These criteria are configured to include the determined MFA channel for user authentication, such as the user's mobile device browser or a specific mobile application, and the content to which the user will be redirected, such as a web page for MFA completion. The system is further configured to adapt the deep link format based on its intended delivery method, generating it either as a QR code for display on a PC browser or as a clickable link within a business message for mobile devices. This configuration enables the Relying Party and/or Identity Provider service to guide the user to the required MFA methods and appropriate channel. The deep link is configured to encapsulate information about the specific MFA methods to be employed, which may vary based on the determined LoA for the transaction. Upon interaction with the generated deep link, the system is configured to direct the user to the appropriate interface, whether a mobile browser page, a specific section of a mobile application, or another designated authentication environment. This process is configured such that the user can efficiently access and complete the required MFA methods through the channel and interface best suited to the security needs of the transaction and the capabilities of the user's device.

In some embodiments, the system is configured to prompt the user to switch to a preferred channel for MFA by utilizing deep links on the respective channel and media. For users accessing the service via a PC browser, the system may be configured to present a QR code with an embedded deep link, facilitating a switch from the user's PC to their mobile device for authentication. Alternatively, the system is configured to send a message containing a deep link directly to the user's mobile device, which may take the form of an SMS, an in-app notification, or other types of mobile-specific communications. The deep links, whether embedded in a QR code or sent via a message, are configured to direct the user to a specific application or web page on their mobile device to complete the MFA process. The system is further configured to generate a unique code or token for the user and incorporate it into the deep link, associating the authentication attempt with the specific user and transaction. Upon the user's interaction with the deep link, the system is configured to seamlessly transition the user to the preferred MFA channel, initiating the appropriate authentication method on the preferred device as required by the determined LoA for the transaction.

In some embodiments, the RP and/or IdP service, which may be application provider, 320 generates a code or token for the user 314 and sends it via a message data object that includes a corresponding deep link. This message data object, which can be a basic or rich media message, incorporates the deep link to allow the destination user's device 310 to receive and render the associated application specified in the link. The RP and/or IdP service is configured to submit and/or provide the generated message data object to the appointed service provider 330, which is configured for relaying the message to the communications service provider 340. The communications service provider 340 then delivers the message data object to the destination subscriber, enabling the multi-factor authentication process. The user receives the authentication information and can interact with the specified application to complete the authentication.

In some embodiments, the user 314 receives the message data object from the communications service provider (CSP) 340 or the service provider (SP) 330 as initiated by the RP and/or IdP service, such as application provider 320. The RP and/or IdP generates the deep link message containing the generated code/token and the required MFA methods based on the LoA. Upon receiving the message data object on their device 310, the user 314 opens the message and selects the deep link. The included code/token is visible to the user 314 and may be automatically copied by the device if the message format matches a known OTP format.

In some embodiments, after the user 314 selects the deep link, the user 314 may be switched from the message data object application to the application designated by the deep link, such as the mobile browser. The deep link is configured to be read by one or more processor and instructs the one or more processor to utilizes the mobile browser to open a specified web page hosted by the RP and/or IdP service, such as application provider 320, to carry out the MFA method as per the required LoA. The user 314 interacts with this RP and/or IdP MFA page, where they may be required to enter the code/token, which their device may offer to paste from the copied code. The user 314 may also need to respond to security questions or enter their registered PIN provided during onboarding. Subsequently, the user is authenticated using their registered decentralized identity.

In some embodiments, the RP and/or IdP service, such as application provider 320, processes the MFA responses according to the required LoA. The RP and/or IdP is configured to check the entered code/token against the generated code/token to ensure validity. Additionally, the RP and/or IdP validates the entered PIN or security question responses and verifies the decentralized identity using methods such as Passkey Webauthn or VC presentation with the VC registry and credential validity. This validation process ensures that an identify of the user 314 is confirmed before allowing the transaction to proceed.

In some embodiments, the RP and/or IdP service, such as application provider 320, validates the MFA outcome according to the required LoA. When the IdP is external to the RP, the IdP is configured to communicate the MFA outcome to the RP using supported federated interfaces. The RP service then responds to the user 314 based on the MFA outcome. When the MFA outcome is correctly verified as per the required LoA, the pending transaction or authentication is deemed successful, and the transaction is authorized. Conversely, when any of the MFA methods fail to be correctly verified as per the required LoA, the pending transaction or authentication is rejected. Thus only properly authenticated users can complete transactions, maintaining the security and integrity of the system.

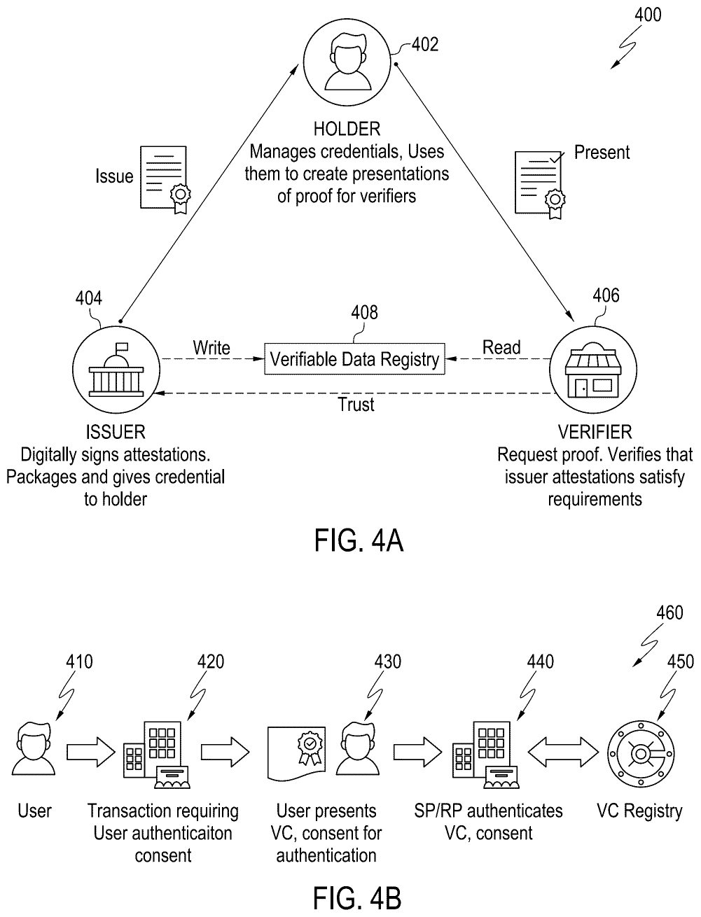

Referring to FIG. 4a, a diagram 400 of example components in an authentication workflow is provided. In some embodiments, the workflow involves one or more entities, such as holder 402, issuer 404, and verifier 406, one or more interacting through a verifiable data registry 408.

In some embodiments, holder 402 is an entity that manages credentials issued by issuer 404. The holder 402 uses these credentials to create presentations of proof for verifiers 406. These credentials are typically stored in a digital wallet, enabling the holder to securely manage and present their credentials when needed. In some embodiments, issuer 404 is configured for generating and digitally signing attestations that package and provide the credential to holder 402. Issuer 404 writes the credential information into the verifiable data registry 408, ensuring that the credential is cryptographically secure and verifiable by other entities. In some embodiments, verifier 406 in configured to request proof from holder 402 and verifies that the issuer's attestations meet specific requirements. Verifier 406 reads the credential information from the verifiable data registry 408 to confirm the authenticity and validity of the credential presented by holder 402.

In some embodiments, the verifiable data registry 408 is configured as a trusted intermediary that stores and manages credential data. Verifiable data registry 408 facilitates secure interactions between issuer 404, holder 402, and verifier 406 by providing a reliable source of credential information. This structure is configured such that credentials are issued, managed, and verified in a secure and trustworthy manner, maintaining the integrity of the authentication workflow.

Referring to FIG. 4b, a diagram 460 illustrating an example workflow for user authentication using Verifiable Credentials (VCs) is provided. In some embodiments, the workflow involves multiple steps that ensure secure user authentication and consent validation. In some embodiments, the process begins with a user 410 initiating a transaction that requires authentication and consent (step 420). This transaction may involve accessing a secure service, authorizing a financial transaction, or any activity that necessitates identity verification.

In some embodiments, once the transaction is initiated, user 410 presents their VC and provides consent for authentication (step 430). The VC, which is stored in the user's digital wallet, contains cryptographic proofs issued by an authorized entity, ensuring its authenticity and integrity. In some embodiments, the service provider or relying party (SP/RP) 440 receives the presented VC and consent from user 410. SP/RP 440 then authenticates the VC and consent by verifying the cryptographic proofs against the records stored in the VC registry 450. The VC registry 450 contains the necessary credential information written by the issuer, allowing SP/RP 440 to confirm the validity and authenticity of the VC. In some embodiments, upon successful verification, SP/RP 440 completes the authentication process and authorizes the transaction. This workflow ensures that only authenticated users can proceed with the transaction, providing a secure and reliable method for user authentication using Verifiable Credentials.

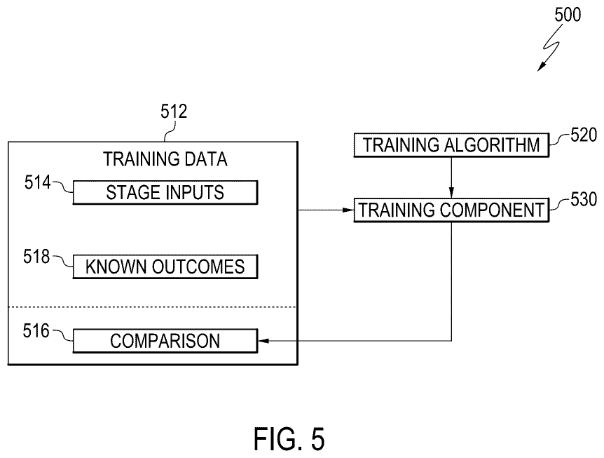

One or more implementations disclosed herein include and/or are implemented using a machine-learning model. For example, one or more of the components of environment 100 are implemented using a machine-learning model and/or are used to train the machine-learning model. FIG. 5 shows an example machine-learning training flow chart, according to some embodiments of the disclosure. Referring to FIG. 5, a given machine-learning model is trained using the training flow chart 500. The training data 512 includes one or more of stage inputs 514 and the known outcomes 518 related to the machine-learning model to be trained. The stage inputs 514 are from any applicable source including text, visual representations, data, values, comparisons, and stage outputs, e.g., one or more outputs from one or more steps from FIGS. 2-4. The known outcomes 518 are included for the machine-learning models generated based on supervised or semi-supervised training, or can based on known labels, such as topic labels. An unsupervised machine-learning model is not trained using the known outcomes 518. The known outcomes 518 includes known or desired outputs for future inputs similar to or in the same category as the stage inputs 514 that do not have corresponding known outputs.

The training data 512 and a training algorithm 520, e.g., one or more of the modules implemented using the machine-learning model and/or are used to train the machine-learning model, is provided to a training component 530 that applies the training data 512 to the training algorithm 520 to generate the machine-learning model. According to an implementation, the training component 530 is provided comparison results 516 that compare a previous output of the corresponding machine-learning model to apply the previous result to re-train the machine-learning model. The comparison results 516 are used by the training component 530 to update the corresponding machine-learning model. The training algorithm 520 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

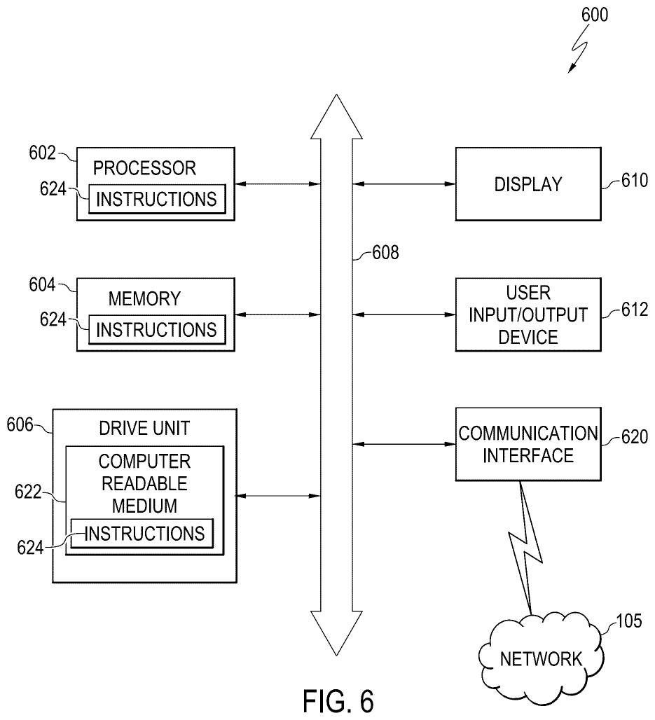

FIG. 6 illustrates an implementation of a computer system that executes techniques presented herein. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,”or a “server”includes one or more processors.

In a networked deployment, the computer system 600 operates in the capacity of a server or as a client user computer in a server-client user environment, or as a peer computer system in a peer-to-peer (or distributed) environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, e.g., a central processing unit (CPU), a graphics processing unit (GPU), or both. The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (i.e., programmed).

The computer system 600 includes a memory 604 that communicates via bus 608. The memory 604 is a main memory, a static memory, or a dynamic memory. The memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by the processor 602 executing the instructions stored in the memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. The sets of instructions 624 resides completely or partially within the memory 604 and/or within the processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to network 105 communicates voice, video, audio, images, or any other data over the network 105. Further, the sets of instructions 624 are transmitted or received over the network 105 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 105, external media, the display 610, or any other components in the computer system 600, or combinations thereof. The connection with the network 105 is a physical connection, such as a wired Ethernet connection, or is established wirelessly as discussed below. Likewise, the additional connections with other components of the computer system 600 are physical connections or are established wirelessly. The network 105 alternatively be directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to the network 105. The network 105 defines one or more networks including wired or wireless networks. The wireless network is a cellular telephone network, an 602.10, 602.16, 602.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having one or more of the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for multi-factor authentication, the method comprising:
receiving, by one or more processors, a user transaction request;
generating, by the one or more processors, an authentication request data object in response to the user transaction request, wherein the authentication request data object comprises an authentication code and a link;
delivering, by the one or more processors, the authentication request data object, including the authentication code and the link, to a pre-registered contact identifier associated with a decentralized identity;
receiving, by the one or more processors, a response data object from a user selecting the link, wherein the response data object is associated with the decentralized identity and the authentication code;
validating, by the one or more processors, a user authentication based on the received response data object; and
authorizing, by the one or more processors, a transaction associated with the user transaction request upon successful validation of the user authentication.

2. The computer-implemented method of claim 1, further comprising registering, by the one or more processors, the decentralized identity and the pre-registered contact identifier during a user onboarding process with an application provider, wherein the registering includes determining a level of assurance for the user, and wherein the generating an authentication request data object is based at least in part on the determined level of assurance.

3. The computer-implemented method of claim 2, wherein the authentication code is generated based on details associated with biometric aspects of the user, details of the transaction, or one or more user-specific details, and the generation of the link is determined based on a desired channel and one or more user authentication methods.

4. The computer-implemented method of claim 1, wherein the generating of the authentication request data object further comprises linking the decentralized identity and the authentication code.

5. The computer-implemented method of claim 1, further comprising applying a machine-learning model to analyze user behavior patterns and actions associated with the user to identify potential fraud before generating the authentication request data object.

6. The computer-implemented method of claim 1, wherein the response data object received from the user further includes biometric data, and the method further comprises combining the received authentication code and the biometric data into a single data packet.

7. The computer-implemented method of claim 6, further comprising using the single data packet to unlock or approve the transaction, wherein the single data packet is required to contain data from both the generated authentication code and the biometric data.

8. The computer-implemented method of claim 1, further comprising verifying the authenticity of the decentralized identity using a secure credential issued by an authorized entity.

9. The computer-implemented method of claim 1, wherein the link directs the user to a secure authentication page, and the method further comprises presenting one or more additional challenges on the secure authentication page based on user behavior analysis.

10. The computer-implemented method of claim 1, wherein the decentralized identity is a verifiable credential stored in a digital wallet on a device of the user, and the method further comprises verifying the verifiable credential as part of the validating the user authentication.

11. A system comprising memory and one or more processors communicatively coupled to the memory, the one or more processors configured to:
receive a user transaction request;
generate an authentication request data object in response to the user transaction request, wherein the authentication request data object comprises an authentication code and a link;
deliver the authentication request data object, including the authentication code and the link, to a pre-registered contact identifier associated with a decentralized identity;
receive a response data object from a user selecting the link, wherein the response data object is associated with the decentralized identity and the authentication code;
validate a user authentication based on the received response data object; and
authorize a transaction associated with the user transaction request upon successful validation of the user authentication.

12. The system of claim 11, wherein the one or more processors are further configured to register the decentralized identity and the contact identifier during a user onboarding process with an application provider.

13. The system of claim 12, wherein the one or more processors are configured to generate the authentication code based on details associated with biometric aspects of the user, details of the transaction, or any other user-specific details.

14. The system of claim 11, wherein the one or more processors are further configured to link the decentralized identity and the authentication code when generating the authentication request data object.

15. The system of claim 11, wherein the one or more processors are further configured to apply a machine-learning model to analyze user behavior patterns and actions associated with the user to identify potential fraud before generating the authentication request data object.

16. The system of claim 11, wherein the response data object received from the user further includes biometric data, and the one or more processors are further configured to combine the received authentication code and the biometric data into a single data packet.

17. The system of claim 16, wherein the one or more processors are further configured to use the single data packet to unlock or approve the transaction, wherein the single data packet is required to contain data from both the generated authentication code and the biometric data.

18. The system of claim 11, wherein the one or more processors are further configured to verify the authenticity of the decentralized identity using a secure credential issued by an authorized entity.

19. The system of claim 11, wherein the link directs the user to a secure authentication page, and the one or more processors are further configured to present one or more additional challenges on the secure authentication page based on a determined level of assurance.

20. One or more non-transitory computer-readable storage media including instructions that, when executed by one or more processors, cause the one or more processors to:
receive a user transaction request;
generate an authentication request data object in response to the user transaction request, wherein the authentication request data object comprises an authentication code and a link;
deliver the authentication request data object, including the authentication code and the link, to a pre-registered contact identifier associated with a decentralized identity;
receive a response data object from a user selecting the link, wherein the response data object is associated with the decentralized identity and the authentication code;
validate a user authentication based on the received response data object; and
authorize a transaction associated with the user transaction request upon successful validation of the user authentication.
